(19) United States
(12) Patent Application Publication
(10) Pub. No.: US 2025/0027476 A1
(43) Pub. Date: Jan. 23, 2025

(54) METHOD AND SYSTEM FOR MOVING A YAW DRIVE IN A WIND TURBINE

(71) Applicant: Siemens Gamesa Renewable Energy A/S, Brande (DK)

(72) Inventor: Andrew Heaton, Red Oak, IA (US)

(21) Appl. No.: 18/769,512

(22) Filed: Jul. 11, 2024

(30) Foreign Application Priority Data
Jul. 21, 2023 (EP) 23187014.8

(51) Int. Cl. F03D 7/02; F03D 80/80

(52) U.S. Cl. CPC F03D 7/0204; F03D 80/821

(57) ABSTRACT

A method, a moving device and a system for moving a yaw drive in a wind turbine is provided.

### CROSS-REFERENCE TO RELATED APPLICATIONS

This application claims priority to EP application Ser. No. 23187014.8, having a filing date of Jul. 21, 2023, the entire contents of which are hereby incorporated by reference.

### FIELD OF TECHNOLOGY

The following relates to a method, a device, and a system for moving a yaw drive in a wind turbine.

### BACKGROUND

Yaw drives are used in wind turbines for controlling an essentially horizontal orientation (or yawing) of a nacelle of a wind turbine in order to enable the rotor of the wind turbine to face into a wind direction to maximize energy yield.

Yaw drives that are used in wind turbines are heavy and large.

For mounting or removing a yaw drive in a wind turbine, the yaw drive has to be moved, at least in part, through an opening in the wind turbine. Such a movement is carried out using a crane and multiple chains.

Against this background, it is a problem to be solved by embodiments of the invention disclosed herein, to provide for possibility for fast, easy and reliable movement of a yaw drive in a wind turbine.

### SUMMARY

An aspect relates to a method for moving a yaw drive in a wind turbine.

In embodiments, the yaw drive may comprise a drive section having for example an electric motor and possibly a gearbox, both covered by a yaw drive housing. Hence, the plurality of moving devices are mountable to the yaw drive housing. At a bottom portion (bottom face area) of the yaw drive a so-called yaw gear is provided, which can be rotated by the motor/gearbox. In a mounted position of the yaw drive, the drive section of the yaw drive is usually mounted to a bedframe or mainframe of a nacelle of a wind turbine such that the yaw gear engages a yaw ring of the wind turbine. Usually, the yaw ring is firmly mounted to the tower or a nonrotating portion of the wind turbine, which also supports (directly or indirectly) the nacelle of the wind turbine.

In embodiments, the method disclosed herein comprises fixing a plurality of moving devices to the yaw drive, in particular to the yaw drive housing, wherein each moving device comprises a connection element by which the moving device is fixable to the yaw drive or to the yaw drive housing, an elongated moving element that is in connection with the connection element, and an end element.

An end element can be an end plate configured for ducting forces from the moving device into the wind turbine, in particular into a bedframe or mainframe of the wind turbine. Each connection element comprises a guide configured to block a movement of the connection element outside of a predefined path relative to the elongated moving element, placing the end elements of the plurality of moving devices on the wind turbine and moving the connection elements along the elongated moving elements of each moving device together with the yaw drive relative to the wind turbine or relative to the bedframe or mainframe of the wind turbine. In the context of the present patent application, the term “fixing” means establishing a connection, in particular a fixed link such as screw and/or bolt connection.

In the context of the present patent application, the term “twisting” means to turn round, in particular to screw in the moving elements inside the connection elements.

In embodiments, the method disclosed herein is based on the principle that a yaw drive to be moved is connected with, i.e. fixed to a plurality of moving devices. These moving devices stand on the wind turbine, in particular around an opening through which the yaw drive is to be moved.

Thus, the moving devices form a support structure that can support the yaw drive on the bead frame or main frame of the wind turbine. This bracing of the yaw drive against the wind turbine is achieved, in particular, without any direct contact between the yaw drive and the wind turbine but indirectly via contact to the moving device which form an interface between the yaw drive and the wind turbine.

Since, according to embodiments of the method disclosed herein, the end elements of the plurality of moving devices are placed on the wind turbine, the moving devices move together with the wind turbine and the yaw drive, which is fixed to the moving devices. In other words, a relative movement between the wind turbine and the yaw drive is prevented by embodiments of the present invention.

By moving the connection elements of the moving devices together with the yaw drive relative to the wind turbine along the elongated moving elements, the yaw drive can be moved up or down in the wind turbine.

Since each connection element comprises a guide configured to block a movement of the connection element outside of a predefined path relative to the elongated moving element, movement of the yaw drive outside a predefined trajectory, in particular a contact between the yaw drive and the wind turbine, is prevented.

According to an embodiment, by fixing the plurality of moving devices to the yaw drive, each elongated moving element is adjusted relative to its corresponding end element such that all connection elements are kept within a given tolerance to a reference plane, in particular kept at the same level.

For adjustment of an elongated moving element relative to the wind turbine and/or relative to the yaw drive, the end element of a moving device is movable with respect to the moving element of the moving device. Thus, the end element may be kept standing on the ground of the wind turbine while the moving element is moved. Alternatively, the moving elements may be moved towards the ground while the connection elements are already fixed to the yaw drive until the end elements make contact to the ground of the wind turbine such that the end elements level out automatically and are placed in parallel to the ground, independent from an inclination angle of the moving elements to the ground.

According to an embodiment, each elongated moving element is moved separately, in particular in an alternating pattern, until a given maximum force is applied to the elongated moving element such that the yaw drive is moved on a trajectory defined by an inclination of the elongated moving elements to the yaw drive.

By moving each moving element separately, a particular moving element is moved before another moving elements is moved such that the yaw drive is moved step by step on a predefined trajectory. Thus, the yaw drive is secured by the connection elements of the moving devices whose moving elements are not moved such that moving the yaw drive out of the trajectory is prevented.

Moving of a moving element by be induced by using a ratchet wench or an automatic screwdriver, for example.

According to an embodiment, all elongated moving elements are moved simultaneously such that the yaw drive is moved exclusively in one single direction or in one single dimension.

By moving all moving elements simultaneously, the yaw drive is moved in a continuous movement and, therefore, very fast.

For simultaneous movement of the moving elements, a plurality of ratchet wrenches and/or a plurality of automatic screw drivers may be used, for example. Alternatively, or additionally, an interface may be used that connects a turning tool such as a ratchet wench or an automatic screwdriver, to all moving devices simultaneously.

According to an embodiment, moving the connection elements along the elongated moving elements comprises twisting the connection elements and/or activating at least one actor attached to the connection elements.

In order to move the yaw drive, the moving elements of each moving device may be twisted or moved by an actor such as an electric motor and/or a hydraulic cylinder and/or a pneumatic cylinder such that each connection element travels along a particular moving element, in particular along a thread of a moving element in a threaded screw connection.

By twisting each moving element separately, a particular moving element is turned before another moving element/s is/are turned such that the yaw drive is moved step by step on a predefined trajectory. Thus, the yaw drive is secured by the connection elements of the moving devices whose moving elements are not turned such that moving the yaw drive out of the trajectory is prevented.

Twisting of a moving element by be induced by using a ratchet wench or an automatic screwdriver, for example.

According to an embodiment, all elongated moving elements are twisted simultaneously such that the yaw drive is moved exclusively in one single direction or in one single dimension.

By twisting all moving elements simultaneously, the yaw drive is moved in a continuous movement and, therefore, very fast.

For simultaneous movement of the moving elements, a plurality of ratchet wrenches and/or a plurality of automatic screw drivers may be used, for example. Alternatively, or additionally, an interface may be used that connects a turning tool such as a ratchet wench or an automatic screwdriver, to all moving devices simultaneously.

According to a further aspect, embodiments of the present invention relate to a moving device for moving a yaw drive within a wind turbine. The moving device comprises a connection element by which the moving device is fixable to the yaw drive, an elongated moving element that is in moving connection with the connection element, and an end element, wherein the connection element comprises a guide configured to block a movement of the connection clement outside of a predefined path relative to the elongated moving element, and wherein the elongated moving element is connected to the end element and movable relative to the end clement in two dimensions.

The moving device disclosed herein is in particular useable for carrying out embodiments of the method disclosed herein.

The moving disclosed herein is based on the principle that a connection element of the moving device is fixable, i.e. attachable to a yaw drive. Thus, by moving the connection element relative to the moving element, i.e. along the moving element, the yaw drive is moved together with the connection element relative to the moving element. For establishing the connection between the connection element and the moving element, a screw connection may be used that urges the connection element into a movement along the moving element. Thus, the moving element servers as an actor for moving the connection element together with the yaw drive.

Further, the elongated moving element is connected to the end element and movable relative to the end element in two dimensions. Thus, the end element may be brought parallel to a ground level and the moving element may be brought into a stable or varying inclination angle to the end element. A relative moving of the moving element with respect to the end element may be used to arrange the end element at a specific position or to arrange the moving element with respect to other moving elements in order to form a specific geometry of multiple moving elements for defining a predetermined trajectory for moving the yaw drive.

According to an embodiment, the connection element comprises a flat element having a plurality of openings for receiving the elongated moving element and a number of connectors for connection with the yaw drive.

The connection element may be connected to the yaw drive by using screws or bolts, for example. In embodiments, the connection element may be connected to the yaw drive by using screws or bolts that are already part of the yaw drive such as housing screws of the yaw drive, for example.

Additionally, or alternatively, the connection element may be connected to the yaw drive by a form fit connection. Thus, the connection element may be formed according to a shape of the yaw drive, thereby maximizing the contact surface between the connection element and the yaw drive.

According to an embodiment, the guide has an opening that overlaps with the opening for receiving the elongated moving element.

The guide may be formed as a flat element such as a plate, that also comprises an opening for a connection with the yaw drive or formed additionally to such a plate. In embodiments, the guide is configured to receive the moving element and to urge the moving element into a predetermined inclination band, i.e. a range of inclination angles with respect to the flat element. Thus, movement of the moving element with respect to the guide is only tolerated within the predetermined inclination band and blocked in case the moving elements moves too wide.

According to an embodiment, the connection element is in a screw connection with the elongated moving clement or the connection element is a lifting element comprising an actor.

An actor for moving the connection along the moving element may comprise an electric motor and/or a hydraulic cylinder and/or a pneumatic cylinder.

According to an embodiment, the guide is fixed in a given angle to the flat element.

By fixing the guide in a given angle to the flat element, the tolerated predetermined inclination band is defined.

According to an embodiment, the elongated moving element is a threaded rod.

According to an embodiment, the elongated moving element comprises an end piece having a diameter that is larger than a boring in the end element and the end piece is surrounded by the end element such that the end element is movable relative to the elongated moving element.

By using an end piece having a diameter that is larger than a boring in the end element, the end piece is secured under the end element against horizontal movement. Thus, the end piece may be moved within the end element but cannot move out of the end element.

According to an embodiment, the end piece has at least partially a round shape.

A round shaped end piece results in a form fit connection independent from the relative position between the end element and the moving element.

According to an embodiment, the elongated moving element has a length between 30 cm and 200 cm, between 50 cm and 100 cm, or between 60 cm and 80 cm, and a diameter between 10 mm and 50 mm, between 15 mm and 35 mm, or between 20 mm and 25 mm.

For example, the moving elements may have a height that is at least half of the height of a yaw drive to be moved.

In embodiments, the moving elements may have a height that enables a lifting height for lifting a yaw drive in a way that ensures that the yaw drive of the drive yaw drive is completely out of an area of the yaw ring for receiving the yaw drive in a wind turbine.

According to an embodiment, the guide has an internal screw thread and/or the flat element has an internal screw thread.

According to a further aspect, embodiments of the present invention relate to a system for moving a yaw drive in a wind turbine. The system comprises a plurality of embodiments of the moving device disclosed herein.

According to an embodiment, the system comprises a fixation element configured to secure the end elements of each of the moving devices in a position relative to each other.

A fixation element such as a plate or 3D-shaped connector, can be used to arrange the moving devices, in particular their moving elements and/or end elements relative to each other and/or relative to a reference point such as an opening through which the yaw drive needs to be moved.

In embodiments, the system disclosed herein is very compact. In embodiments, the system comprises at least three moving devices being mounted to a yaw drive. The ratio of a maximum diameter of the system to a diameter of a yaw drive to be moved may be smaller than 2, in particular smaller than 1.5, more particular smaller than 1.3, or 1.2. Thus, in embodiments the system may be placed and used in a wind turbine easily, i.e. without any risk for an operator of the system.

Further, in embodiments the system disclosed herein is configured for lifting the yaw drive in a lifting direction that is parallel to an axis of rotation of a yaw actor for moving the yaw drive in a wind turbine.

The connection elements may be connected to a yaw drive at any position on an outer perimeter of the yaw drive. In embodiments, the connection elements may be connected to screws or bolts on a cover of the yaw drive.

According to a further aspect, embodiments of the present invention relate to using an embodiment of the system disclosed herein for moving a yaw drive in a wind turbine.

According to a further aspect, embodiments of the present invention relate to a wind turbine. The wind turbine disclosed herein comprises a yaw drive and at least one embodiment of the moving device disclosed herein or at least one system comprising a yaw drive and at least one, three moving devices.

According to a further aspect, embodiments of the present invention relate to a procedure or method for using an embodiment of the system disclosed herein for moving a yaw drive in a wind turbine.

Additionally and/or alternatively, a further aspect is disclosed, and/or in particular as an embodiment of one of the precedingly described aspects and/or embodiments, namely, a method for moving a yaw drive in a wind turbine, in particular an offshore wind turbine, further in particular a floating offshore wind turbine, and/or for feeding electrical and/or chemical energy to an electricity and/or chemical grid, the method comprising the following steps:
executing steps of an embodiment or of a combination of embodiments of a method as disclosed supra, and/or operating an embodiment of a device as disclosed supra,
generating, by the wind turbine, electrical power and/or electrical energy, and in particular generating at least partially from the electrical energy, further in particular, by transforming electrical energy into hydrogen by electrolysis, chemical energy in form of a gas or liquid, in particular in the form of hydrogen,
transmitting, at least partially, the electrical power, the electrical energy, and/or the chemical energy to an energy receiving arrangement, in particular wherein the receiving arrangement is not positioned in international waters, is positioned onshore, and/or is positioned within a 12-miles-zone of a respective sovereign national state over which the respective state has jurisdiction, and
supplying, at least partially, the electrical power, the electrical energy, and/or the chemical energy to an electrical and/or chemical utility grid, in particular to an onshore electrical and/or chemical utility grid and/or chemical/electrical storage.

The term “chemical energy” includes means for storing energy in a chemical substance such as in hydrogen. A chemical energy grid could for example be a gas (hydrogen) grid and/or storage device.

It is to be understood that the features mentioned above, for example twisting the elongated moving elements of each moving device such that the connection elements are moved along the moving elements together with the yaw drive relative to the wind turbine along the elongated moving elements and the connection element comprising a guide configured to block a movement of the connection element outside of a predefined path relative to the elongated moving element, and those yet to be explained below can be used not only in the respective combinations indicated, but also in other combinations or in isolation, without leaving the scope of embodiments of the present invention. The features of the different aspects, embodiments, and/or methods of the invention can be combined with each other unless noted to the contrary.

### BRIEF DESCRIPTION

Some of the embodiments will be described in detail, with references to the following Figures, wherein like designations denote like members, wherein:

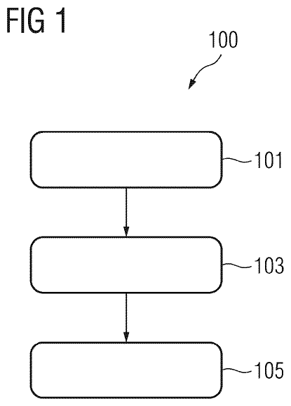

FIG. 1 shows an embodiment of the method for moving a yaw drive in a wind turbine according embodiments of the invention disclosed herein;

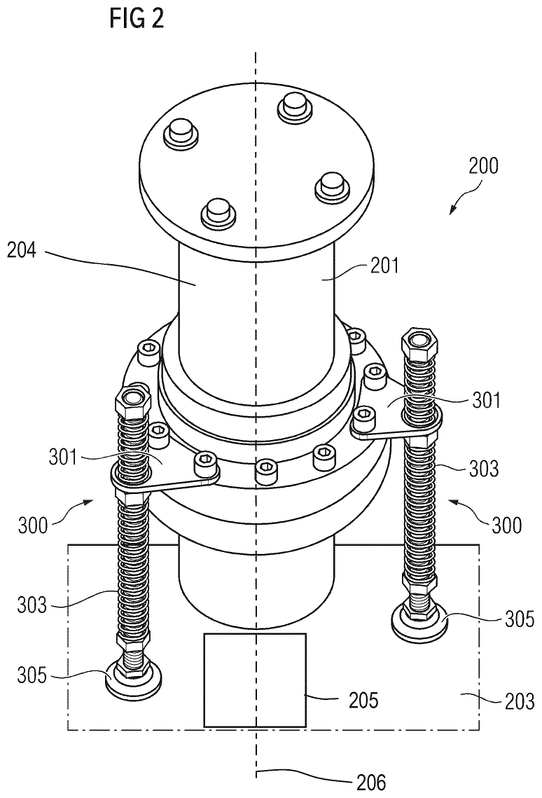

FIG. 2 shows a system for moving a yaw drive in a wind turbine comprising a plurality of moving devices, according to an embodiment of the invention disclosed herein; and

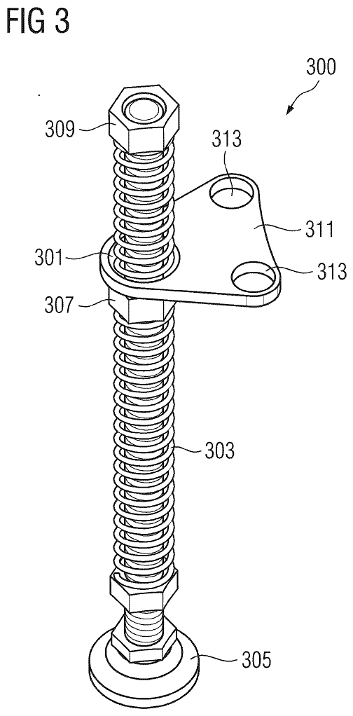

FIG. 3 shows a detailed perspective of a moving device according to FIG. 2.

### DETAILED DESCRIPTION

In FIG. 1, a method 100 for moving a yaw drive in a wind turbine is shown.

In embodiments, the method 100 comprises a fixation step 101, in which a plurality of moving devices are fixated to the yaw drive 201, wherein each moving device comprises a connection element by which the moving device is fixable to the yaw drive, an elongated moving element that is in a screw connection with the connection element, and an end element, and wherein each connection element comprises a guide configured to block a movement of the connection element outside of a predefined path relative to the elongated moving element.

Further, in embodiments the method 100 comprises a placing step 103, in which the end elements of the plurality of moving devices are placed on the wind turbine, and a twisting step 105, in which the elongated moving elements of each moving device are twisted such that the connection elements are moved along the moving elements together with the yaw drive relative to the wind turbine along the elongated moving elements.

In FIG. 2, a system 200 for moving a yaw drive 201 in a wind turbine 203 is shown. In embodiments, the system 200 comprises a plurality of moving devices 300.

Each moving device 300 comprises a connection element 301 by which the moving device is fixed to the yaw drive 201, an elongated moving element 303 that is in connection, in particular in a screw connection with the connection element 301, and an end element 305.

Each connection 301 element comprises a guide 307 configured to block a movement of the connection element 301 outside of a predefined path relative to the elongated moving element 303 or vice versa.

Each elongated moving clement 303 is connected to an end element 305 and movable relative to the end element 305 in two dimensions.

In FIG. 3, a moving device 300 is shown in detail. The moving device 300 comprises a connection element 301 configured to be fixed to a yaw drive, an elongated moving element 303 in form of a threaded rod that is in a screw connection with the connection element 301, and an end element 305.

By turning a nut 309 fixed, in particular welded, to the moving element 303, the moving clement can be twisted, i.e. turned such that the connection element 301 moves along the moving clement 303.

The connection element 301 comprises a flat element 311, a guide 307 and openings 313 for receiving screws, for example, to connect with the yaw drive 201.

It has to be noted that embodiments of the invention have been described with reference to different subject matters. In particular, some embodiments have been described with reference to apparatus type claims such as the connection element comprising a guide configured to block a movement of the connection element outside of a predefined path relative to the elongated moving element, whereas other embodiments have been described with reference to method type claims such as twisting the elongated moving elements of each moving device such that the connection elements are moved along the moving elements together with the yaw drive relative to the wind turbine along the elongated moving elements. However, a person skilled in the conventional art will gather from the above description that, unless otherwise notified, in addition to any combination of features belonging to one type of subject matter, also any combination between features relating to different subject matters, in particular between features of the apparatus type claims and features of the method type claims such as a combination of the connection element comprising a guide configured to block a movement of the connection element outside of a predefined path relative to the elongated moving element while twisting the elongated moving elements of each moving device such that the connection elements are moved along the moving elements together with the yaw drive relative to the wind turbine along the elongated moving elements is considered as to be disclosed within this application.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

### REFERENCE SIGN LIST

100 method
101 fixation step
103 placing step
105 twisting step
200 system
201 yaw drive
203 wind turbine
204 yaw drive housing
205 yaw gear
206 longitudinal axis
300 moving device
301 connection element
303 elongated moving element
305 end element
307 guide
309 nut
311 flat element
313 openings

1. A moving device for moving a yaw drive of a wind turbine within the wind turbine,
wherein the moving device includes a connection element, an elongated moving element, and an end element,
wherein the connections element is configured for enabling the moving device to be fixable to the yaw drive and such that the connection element is connectable to the yaw drive by using screws or bolts that are already part of the yaw drive,
wherein the elongated moving element is in connection with the connection element and includes a guide configured to block a movement of the connection element outside of a predefined path relative to the elongated moving element, and
wherein the end element is configured for being placed on the wind turbine, on a bed frame, or on a mainframe of the wind turbine.

2. The moving device according to claim 1, wherein the connection element comprises:
at least one flat element having at least one opening, a plurality of openings, for receiving the elongated moving element, and
at least one connector, two connectors, for connecting the flat element with the yaw drive.

3. The moving device according to claim 1, wherein the guide has an opening that overlaps with an opening for receiving the elongated moving element.

4. The moving device according to claim 1,
wherein the connection element is in a screw connection with the elongated moving element, and/or
wherein the connection element is a lifting element comprising an actor.

5. The moving device according to claim 1, wherein the elongated moving element comprises an end element having a diameter that is larger than a bore in the end element and the end piece is surrounded by the end element such that the end element is movable or rotatable relative to the elongated moving element.

6. The moving device according to claim 1, wherein the elongated moving element has a length between 30 cm and 200 cm, between 50 cm and 100 cm, or between 60 cm and 80 cm, and a diameter between 10 mm and 50 mm, between 15 mm and 35 mm, or between 20 mm and 25 mm.

7. A system for moving a yaw drive in a wind turbine,
wherein the system comprises at least three moving devices, according to claim 1.

8. The system according to claim 7, further comprising a fixation element configured to secure the end elements of each of the moving devices in a position relative to each other.

9. The system according to claim 7, further comprising a yaw drive, wherein the plurality of moving drives is mounted to the yaw drive.

10. The system according to claim 9, wherein a maximum diameter of the system to a diameter of the yaw drive is less than 1.5, less than 1.3, or less than 1.2.

11. A wind turbine for generating electrical energy, wherein the wind turbine comprises a nacelle having a generator, a rotor having at least one rotor blade, the rotor being configured for rotating a generator of the nacelle, and at least one system according to claim 7.

12. A method for moving a yaw drive in a wind turbine, the method comprising:
fixing at least three moving devices according to claim 1 to the yaw drive,
placing the end elements of the plurality of moving devices on the wind turbine, on a bed frame or on a mainframe of the wind turbine, and
moving the connection elements along the elongated moving elements of each moving device together with the yaw drive, relative to the wind turbine.

13. The method according to claim 12, wherein by fixing the plurality of moving devices to the yaw drive, each elongated moving element is adjusted relative to its corresponding end element such that all connection elements are kept within a given tolerance to a reference plane, kept at the same level.

14. The method according to claim 12,
wherein each elongated moving element is moved separately, in an alternating pattern, until a given maximum force is applied to the elongated moving element such that the yaw drive is moved, on a trajectory defined by an inclination of the elongated moving elements to the yaw drive, or
wherein all elongated moving elements are moved simultaneously such that the yaw drive is moved only in one dimension or direction.

15. The method according to claim 12, wherein moving the connection elements along the elongated moving elements comprises twisting the connection elements and/or activating at least one actor attached to the connection elements.
